(19) United States
(12) Patent Application Publication
(10) Pub. No.: US 2026/0219131 A1
(43) Pub. Date: Jul. 30, 2026

(54) METHOD AND MEASURING SYSTEM FOR DETERMINING THE EFFECTIVE FOCAL LENGTH OF AN OPTICAL SYSTEM

(71) Applicant: TRUMPF Lasersystems for Semiconductor Manufacturing SE, Ditzingen (DE)

(72) Inventors: Stefan Piehler, Stuttgart (DE); Tolga Ergin, Bietigheim-Bissingen (DE)

(21) Appl. No.: 19/529,180

(22) Filed: Feb. 4, 2026

Related U.S. Application Data
(63) Continuation of application No. PCT/EP2024/070155, filed on Jul. 16, 2024.

(30) Foreign Application Priority Data
Aug. 10, 2023 (DE) 10 2023 121 451.9

(51) Int. Cl. G01M 11/02; G01M 11/00

(52) U.S. Cl. CPC G01M 11/0228; G01M 11/0207; G01M 11/332

(57) ABSTRACT

A method for determining an effective focal length of an optical system includes arranging an optical measuring device in an image-side focal plane of the optical system, directing an input beam at a first angle α₁ relative to an object-side optical axis, and determining a first lateral position (x₁, y₁) of a first point of incidence of a first output beam on the optical measuring device, directing the input beam at a second angle α₂ different from the first angle α₁ relative to an object-side optical axis, and determining a second lateral position (x₂, y₂) of a second point of incidence of a second output beam on the optical measuring device, and determining the effective focal length EFL of the optical system from a mutual distance ΔL=\sqrt{(x₂−x₁)²+(y₂−y₁)²} between the first point of incidence and the second point of incidence, and from a formula ΔL=EFL*tan(α₂−α₁).

### CROSS REFERENCE TO RELATED APPLICATIONS

This application is a continuation of International Application No. PCT/EP2024/070155 (WO 2025/031738 A1), filed on Jul. 16, 2024, and claims benefit to German Patent Application No. DE 10 2023 121 451.9, filed on Aug. 10, 2023. The aforementioned applications are hereby incorporated by reference herein.

### FIELD

Embodiments of the present invention relate to a method and a measuring system for determining the effective focal length of an optical system. The optical system may include one or more focusing, defocusing or beam-deflecting optical elements such as lenses, mirrors or the like. Such optical systems can be components of laser processing machines, which allow a laser beam to be focused precisely on a target object.

### BACKGROUND

An optical system is distinguished by a number of characteristic properties that may be used to describe its input and output behavior geometrically and optically: the object-side focal plane FFP (front focal plane), an image-side focal plane BFP (back focal plane), the object-side and image-side main planes and the object-side and image-side focal lengths FFL (front focal length) and BFL (back focal length), wherein the FFL indicates the distance between the object-side main plane and the object-side focal plane FFP, and the BFL indicates the distance between the image-side main plane and the image-side focal plane BFP.

An optical system may also be summarized as a black box, by way of a thin lens, to calculate the input and output behavior. The main planes of a thin lens coincide and lie in the lens plane. Therefore, for a thin lens, the image-side focal length BFL and the object-side focal length FFL are identical and may be described collectively as effective focal length EFL. When viewing an optical system as a black box, it is sufficient for most applications to describe the input and output behavior of the optical system by way of the effective focal length EFL as well as possibly the position of the object-side focal plane FFP and the image-side focal plane BFP.

Various methods for determining the effective focal length EFL of an optical system have already been proposed. However, the known methods require the use of collimated input beams or input beams of known divergence to measure the system.

### SUMMARY

Embodiments of the present invention provide a method for determining an effective focal length of an optical system. The method includes arranging an optical measuring device in an image-side focal plane of the optical system, directing an input beam from an object side of the optical system onto the optical system at a first angle α₁ relative to a direction of an object-side optical axis, and determining a first lateral position (x₁, y₁) of a first point of incidence of a first associated output beam on the optical measuring device, directing the input beam from the object side onto the optical system at a second angle α₂ relative to the direction of the object-side optical axis, the second angle α₂ being different from the first angle α₁, and determining a second lateral position (x₂, y₂) of a second point of incidence of a second associated output beam on the optical measuring device, and determining the effective focal length EFL of the optical system from a mutual distance ΔL=\sqrt{(x₂−x₁)²+(y₂−y₁)²} between the first point of incidence the first output beam and the second point of incidence of the second output beam, and from a formula ΔL=EFL*tan(α₂−α₁).

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic illustration of the principle of measuring the image-side effective focal length of an optical system according to some embodiments;

FIG. 2 shows a schematic illustration of a measuring system for determining the image-side effective focal length and the focal plane of an optical system according to some embodiments;

FIG. 3 shows a schematic illustration of the measurement of the image-side focal plane of an optical system according to some embodiments;

FIG. 4 shows a schematic illustration of the calculation of the z-coordinate of the focal plane of an optical system according to some embodiments; and

FIG. 5A, and FIG. 5B show an alternative object-side configuration of the measuring system from FIG. 2 in two different working positions according to some embodiments.

### DETAILED DESCRIPTION

Embodiments of the present invention provide a method and a measuring system for the precise determination of the effective focal length of an optical system, the method and measuring system being able to be implemented with input beams the divergence characteristics of which do not have to be known.

According to some embodiments, a method for determining the effective focal length of an optical system, comprising the following steps:
a) arranging an optical measuring device in the image-side focal plane of the optical system;
b) directing an input beam from the object side of the optical system onto the optical system at a first angle (α₁) relative to the direction of the object-side optical axis, and ascertaining the lateral position (x₁, y₁) of the point of incidence of the associated output beam on the measuring device;
c) directing the input beam from the object side onto the optical system at a second angle (α₂≠α₁) relative to the direction of the object-side optical axis, and ascertaining the lateral position (x₂, y₂) of the point of incidence of the associated output beam on the measuring device;
d) calculating the effective focal length (EFL) of the optical system from the mutual distance ΔL=\sqrt{(x₂−x₁)²+(y₂−y₁)²} between the points of incidence of the output beams and from the formula ΔL=EFL*tan(α₂−α₁).

The input beam is first directed onto the optical system at a first angle α₁ and then, in a second step, is deflected and directed onto the optical system at a second angle α₂. The associated points of incidence are measured by the measuring device arranged in the image-side focal plane, and their mutual distance ΔL is calculated. The effective focal length EFL may then be calculated from this calculated distance ΔL and the known angles α₁ and α₂. Since no two input beams coming from different beam sources are used, but rather just one beam that is deflected at an angle for the second measurement, the divergence characteristics of the input beam or input beam bundle are irrelevant. It is therefore possible to use collimated, divergent or convergent beam bundles as input beams. The quality of the beam source therefore does not have to be subject to stringent requirements. The points of incidence of the associated output beams are ascertained in the same way in both measuring steps, meaning that for example any divergence in the input beam does not affect the measurement result of the effective focal length EFL. In the case of an input beam bundle, the point of incidence of the main beam is used for the measurement, wherein the main beam is defined by the fact that it passes through the lens without being influenced geometrically.

As an alternative, the points of incidence of the output beams may each be determined by ascertaining the intensity centroid or area centroid of the power density distribution of the output beam bundle. Any divergent input beams do not affect the accuracy of the measurement result of the effective focal length EFL, since the optical measuring device is located in the image-side focal plane. For both measurements, however, the points of incidence must be determined in the same way.

Furthermore, it is expedient to direct further input beams onto the optical system at first and second angles and to determine the lateral position of the points of incidence of the associated output beams on the measuring device in order to increase the accuracy of the calculation of the effective focal length by measuring the distance between the further points of incidence. For this purpose, it is possible for example to use the least squares method when calculating the effective focal length in order to statistically compensate for any setting or measurement inaccuracies.

To carry out the method, the optical measuring device must be arranged in the image-side focal plane. The position of the image-side focal plane of the optical system may already be known, for example by way of reference marks in the installation space of the optical system. However, if the position of the image-side focal plane is not known, it may be determined using the following method:
an input beam is directed from the object side onto the optical system and the lateral position of the intensity centroid or the area centroid of the associated output beam bundle on the measuring device are ascertained for different positions of the measuring device in the direction of the image-side optical axis of the optical system (z-direction);
the input beam is displaced in parallel and the lateral position of the intensity centroids or area centroids of the output beam bundle of the displaced input beam on the optical measuring device are ascertained for different positions of the measuring device in the direction of the image-side optical axis of the optical system (z-direction);
the lateral positions of the intensity centroids or area centroids of the output beam bundle of the non-displaced input beam and the lateral positions of the intensity centroids or area centroids of the output beam bundle of the displaced input beam for the different positions of the measuring device, plotted on the z-direction axis, are each connected to one another by curves and the point of intersection of the two curves is ascertained, the z-coordinate of which indicates the position of the image-side focal plane.

This approach takes advantage of the fact that the output beams of exactly parallel main beams (=middle beams) of a beam bundle that enter a focusing optical system intersect in the image-side focal plane BFP. As a result of the parallel displacement of the input beam or main beam of an input beam bundle and the determination of the lateral position of the points of incidence of the associated output beams on the measuring device for different positions of the measuring device in the z-direction, it is possible to calculate the point of intersection of the output beams of the parallel input beams, and thus the z-coordinate of the image-side focal plane. The measuring device may then be placed in this z-position, and the method for ascertaining the effective focal length may be carried out. It is also preferably possible to use multiple parallel input beam pairs to determine the image-side focal plane, and the image-side focal plane is able to be calculated with greater accuracy from the points of incidence of the associated output beams.

For seamless functioning of the method according to embodiments of the invention, it is possible to measure the angles of the input beams on the object side of the optical system and correct them in the event of deviations from a reference value in order to avoid erroneous results both when calculating the effective focal length and when determining the image-side focal plane. Such a measurement may also be carried out in order to check and if necessary correct the parallel displacement of the input beams.

The measuring system according to embodiments of the invention for carrying out the method according to embodiments of the invention is distinguished in that it has a beam source for generating input beams on the object side of the optical system, an optical measuring device on the image side of the optical system that is arranged so as to be linearly adjustable in the direction of the image-side optical axis of the optical system, and at least one apparatus for changing the direction of the input beams generated by the beam source.

The at least one apparatus for changing the direction of the input beams preferably has an apparatus for achieving angular deflection of an input beam, in particular a rotatable mirror. Rotating the mirror slightly makes it possible to generate the two different angles of the input beam for calculating the effective focal length of the optical system.

In addition, if the direction-changing apparatus is arranged so as to be adjustable transverse to the direction of the object-side optical axis of the optical system, then the apparatus may also be used to achieve a parallel displacement of an input beam, this being required to determine the image-side focal plane of the optical system. As an alternative, provision may be made for two beam sources that generate the two parallel input beams.

Instead of a displaceable rotating mirror, the measuring system could also have two identical, separately rotatable wedge plates for achieving angular deflection and/or parallel displacement of the input beams.

Further advantages arise if the measuring system has an angle-measuring apparatus for the one or more input beams. This makes it possible to ensure that the input beams have the desired angles for calculating the effective focal length and/or the image-side focal plane.

The measuring system may in this case preferably have an autocollimator, which serves as an angle-measuring apparatus and as a beam source.

The optical measuring device may advantageously be provided with a camera chip, which is connected to an image evaluation apparatus. The image evaluation apparatus detects the lateral position of the points of incidence of the output beams and calculates the effective focal length and optionally also the z-coordinate of the image-side focal plane.

It is also possible to provide a beamsplitter. This may be placed upstream of the optical system and reflect back a portion—for example 50%—of the input beam. The autocollimator is able to identify the angle or a change of angle of the input beam from the portion reflected back. In the event of deviations from a reference value for the angle, the apparatus for changing the direction of the input beam may be recorrected accordingly.

The optical system to be measured may be formed of one or more focusing, defocusing or beam-deflecting optical elements such as mirrors, lenses or stops. The optical system may for example be part of a focusing unit, which is arranged in particular at the end of the beam path of a laser system for generating EUV (extreme ultraviolet) light. The focusing unit serves here to focus the laser beam on a target material, in particular a tin droplet. When the target material is exposed, the desired extreme ultraviolet radiation is generated. EUV systems are used, inter alia, in semiconductor manufacture. Embodiments of the invention therefore also relates to a focusing unit having an integrated measuring system according to embodiments of the invention for controlling and readjusting the focal point of a laser beam. The measurement of the focusing unit, for example of an EUV system, in accordance with a method according to embodiments of the invention with the aid of a measuring system according to embodiments of the invention ensures seamless functioning of such EUV systems, since the target material is able to be exposed reliably.

Further features and advantages of the embodiments of the invention will become apparent from the drawing and the description of the drawing. The embodiments shown and described should not be understood as an exhaustive list, but rather they have an exemplary character.

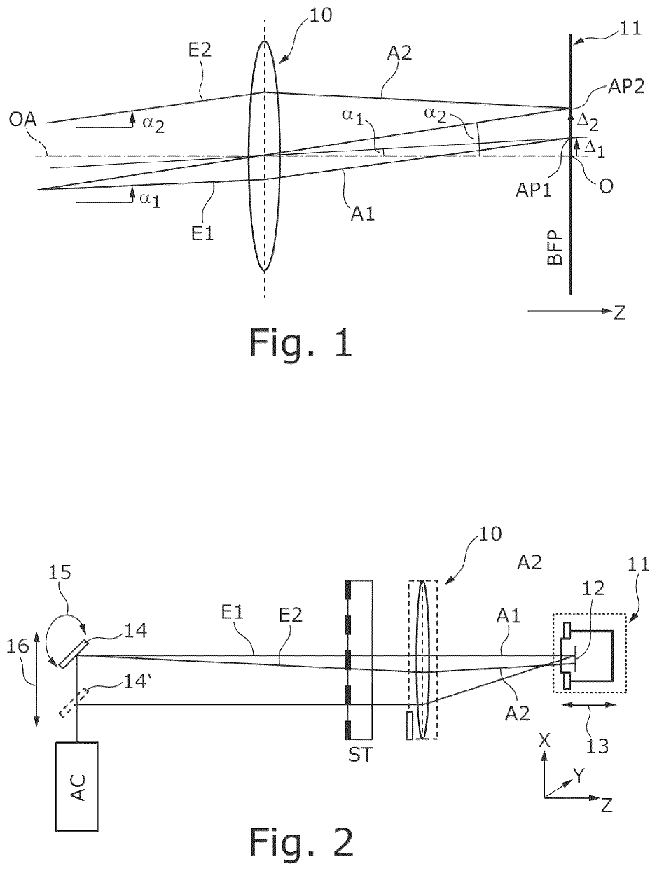

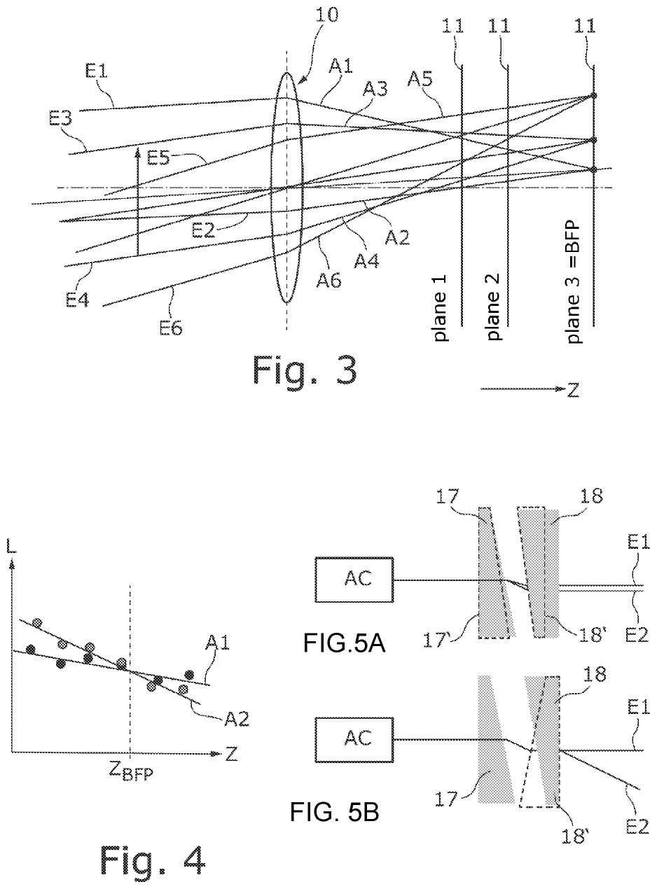

FIG. 1 schematically illustrates the determination of the effective focal length EFL of an optical system 10, which has been replaced by a thin lens for a black-box view, but may actually consist of multiple optical elements such as lenses, mirrors or stops. For the measurement, an optical measuring device 11, which may in particular have a camera chip 12 (see FIG. 2), is arranged in the image-side focal plane BFP of the optical system 10. The position of the image-side focal plane BFP may already be known, for example by way of a mark on a housing of a focusing unit contained in the optical system, or the position of the image-side focal plane BFP may be determined in accordance with the method explained in FIGS. 3 and 4, in order to be able to arrange the measuring device 11 for determining the effective focal length EFL in the image-side focal plane BFP.

To measure the effective focal length EFL, an input beam E1 is sent through the optical system 10, inclined at an angle α₁ in relation to an object-side optical axis OA of the optical system 10. However, it is also possible here to select the angle α₁=0.

The optical axis OA defines the z-direction of the measuring arrangement. The output beam A1 exiting downstream of the optical system 10 impinges on the optical measuring device 11 at a point AP1. The distance Δ₁ between the point of incidence AP1 and the point of passage 0 of the optical axis OA through the image-side focal plane BFP is measured.

An input beam E2 is then directed onto the optical system 10 at a second angle α₂. The beam E2 may in this case come from the same beam source and does not—as illustrated in FIG. 1—have to be displaced parallel to the beam E1, but rather only in a manner inclined by the other angle α₂ with respect to the optical axis OA. The displacement illustrated in FIG. 1 between the beams E1 and E2 serves only to make the illustration clearer. The beam A2 exiting the optical system impinges on the measuring device 11 at a point AP2. The distance Δ₂ between the point of incidence AP2 and the point of passage 0 of the optical axis OA through the image-side focal plane BFP is measured. The effective focal length EFL may be calculated from the difference between the distances ΔL=Δ₂−Δ₁ and the difference between the angles α₂−α₁ using the following formula: ΔL=EFL*tan(α₂−α₁).

FIG. 2 shows a basic measuring arrangement able to be used to determine the effective focal length EFL of an optical system 10 according to FIG. 1. On the image side of the optical system 10, provision is made for an optical measuring device 11 having a camera chip 12, wherein the measuring device 11 is arranged so as to be adjustable in the z-direction, this being indicated by the double-headed arrow 13. It is thereby possible to arrange the measuring device 11 exactly in the image-side focal plane BFP of the optical system.

An autocollimator AC is arranged on the object side of the optical system 10 and has a beam source, not shown in more detail here, and an angle-measuring apparatus. The input beams E1, E2 generated by the autocollimator AC are deflected by a direction-changing apparatus 14, here a rotating mirror—indicated by the double-headed arrow 15—and directed onto the optical system 10. The rotating mirror 14 makes it possible to irradiate the input beams E1 and E2 onto the optical system 10 at different angles α₁, α₂, and thus to measure the effective focal length EFL in accordance with FIG. 1. A beamsplitter ST is also arranged upstream of the optical system 10 and reflects back a portion of the input beams E1, E2. From this portion, the autocollimator AC is able to carry out the measurement and, if necessary, correct the angle of the input beams E1, E2.

The rotating mirror 14 may also be displaced in the x-direction—here into a position 14′—which is indicated by the double-headed arrow 16. This displacement capability is necessary to determine the image-side focal plane BFP in accordance with the method explained in FIGS. 3 and 4. However, the adjustment does not necessarily have to take place in the x-direction. Any linear displacement capability of the direction-changing apparatus 14 lateral to the z-direction allows the image-side focal plane BFP to be determined.

FIG. 3 shows how the image-side focal plane BFP of an optical system 10 is able to be determined. For this purpose, at least one pair of parallel input beams E1, E2; E3, E4; E5, E6 is sent through the optical system and the points of incidence of the associated output beams A1, A2; A3, A4; A5, A6, or the intensity centroids or area centroids in the case of an output beam bundle, on the measuring device 11 are determined. This determination is carried out for different positions of the measuring device in the z-direction (plane 1 to plane 3). In the image-side focal plane of a lens, parallel beams meet at one point at the entrance. This fact is exploited for the measurement according to FIG. 3. In the example illustrated, the position “plane 3” of the measuring device corresponds to the position of the image-side focal plane BFP. However, it is not necessary to position the measuring device 11 exactly in the focal plane to determine the BFP. As shown in FIG. 4, it is possible to use the measurement results from the positioning of the measuring device 11 in other positions in the z-direction to determine the position of the image-side focal plane BFP in the z-direction. For this purpose, the lateral positions L of the points of incidence AP1, AP2 of the output beams A1, A2 of two parallel input beams E1, E2 are plotted on the z-direction axis, these lateral positions L being ascertained for different positions of the measuring device in the z-direction. The points of incidence AP1 and AP2 are each connected to one another by a straight line, and the beam direction of the output beams A1 and A2 is thereby determined. The point of intersection S of the beams A1 and A2 defines the position zBFP of the image-side focal plane BFP in the z-direction. It is also possible to use multiple parallel input beam bundles E1, E2; E3, E4; E5, E6 to increase measurement accuracy, as shown in FIG. 3, and the profile of the output beams A1, A2; A3, A4; A5, A6 and their mutual points of intersection may be ascertained from the points of incidence of the associated output beams A1, A2; A3, A4; A5, A6.

This determination of the image-side focal plane BFP also works for non-collimated input beams. In this case, the focal point of the parallel-displaced beams is located downstream or upstream of the image-side focal plane, depending on whether the input beams are divergent or convergent. However, in the case of parallel displacement of such input beams, the lateral position of the associated output beams on the measuring device does not change if it is placed exactly in the image-side focal plane BFP. This characteristic may therefore be exploited for all types of input beams to determine the image-side focal plane.

FIG. 5 illustrates an alternative configuration of the object side of the measuring system from FIG. 2, in which the direction-changing apparatus 14 is formed not by a displaceable rotating mirror, but by two identical parallel wedge plates 17, 18. The two wedge plates 17, 18 are able to be rotated independently of one another here.

FIG. 5A shows the two wedge plates 17, 18 in a position enabling parallel displacement of an input beam E1. For this purpose, both wedges 17, 18 are rotated such that the input beam E1 remains parallel when entering the optical system 10. The parallelism is able to be controlled by the back-reflection of the beamsplitter ST and the autocollimator AC. The input beam E1 is displaced laterally by the rotation of the wedge plates 17, 18 into the positions 17′, 18′. The wedge plate pair 17, 18 acts here as a “plane-parallel plate” that is rotated, that is to say the beam E1 is shifted in parallel on a circular path. The wedge plates 17, 18 are in this case preferably rotated together about a common axis of rotation by the same angle of rotation.

In order to set a defined angular offset of the input beam E1, both wedges 17, 18 are turned counter to one another about their optical axis, as illustrated in FIG. 5B. The two wedge plates 17, 18 then act like a single wedge plate with a “settable” wedge angle. The angular displacement of the input beam E1 may in turn be measured by the interaction of the beamsplitter ST with the autocollimator AC.

However, the wedge plates 17, 18 may also be provided with a beamsplitter coating on the entrance and exit sides. It is then possible to dispense with a separate beamsplitter ST in the measuring system.

Instead of providing a linearly adjustable rotating mirror 14 or wedge plates 17, 18, the beam source itself could of course also be displaced and/or angularly adjusted to carry out the measurements.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for determining an effective focal length of an optical system, the method comprising:
a) arranging an optical measuring device in an image-side focal plane of the optical system;
b) directing an input beam from an object side of the optical system onto the optical system at a first angle α₁ relative to a direction of an object-side optical axis, and determining a first lateral position (x₁, y₁) of a first point of incidence of a first associated output beam on the optical measuring device;
c) directing the input beam from the object side onto the optical system at a second angle α₂ relative to the direction of the object-side optical axis, the second angle α₂ being different from the first angle α₁, and determining a second lateral position (x₂, y₂) of a second point of incidence of a second associated output beam on the optical measuring device; and
d) determining the effective focal length EFL of the optical system from a mutual distance ΔL=\sqrt{(x₂−x₁)²+(y₂−y₁)²} between the first point of incidence the first output beam and the second point of incidence of the second output beam, and from a formula ΔL=EFL*tan(α₂−α₁).

2. The method as claimed in claim 1, wherein the first point of incidence of the first output beam or the second point of incidence of the second output beam is determined by determining an intensity centroid of a power density distribution of the first output beam or of the second output beam.

3. The method as claimed in claim 1, wherein the first point of incidence) of the first output beam or the second point of incidence of the second output beam is determined by determining an area centroid of a power density distribution of the first output beam or of the second output beam.

4. The method as claimed in claim 1, wherein the first point of incidence of the first output and the second point of incidence of the second output beam are determined in a same way.

5. The method as claimed in claim 1, wherein the input beam is directed onto the optical system at each of the first angle and the second angle multiple times, and each of the first lateral position of the first point of incidence of the first associated output beam and the second lateral position of the second point of incidence of the second associated output beam on the measuring device is determined multiple times in order to increase an accuracy of the effective focal length EFL.

6. The method as claimed in claim 1, further comprising determining the image-side focal plane of the optical system by:
directing the input beam from the object side onto the optical system, and determining third lateral positions of an intensity centroid or an area centroid of a third associated output beam on the optical measuring device for different positions of the optical measuring device in a direction of an image-side optical axis of the optical system;
displacing the input beam in parallel, and determining fourth lateral positions of an intensity centroid or an area centroid of a fourth associated output beam on the optical measuring device for different positions of the optical measuring device in the direction of the image-side optical axis of the optical system;
plotting the third lateral positions and the fourth lateral positions on the image-side optical axis, connecting the third lateral positions to each other by a first curve and connecting the fourth lateral positions to each other by a second curve, and determining a point of intersection of the first curve and the second curve as a position of the image-side focal plane.

7. The method as claimed in claim 1, wherein the first angle and the second angle of the input beam on the object side of the optical system are measured and corrected in an event of deviations from a reference value.

8. A measuring system for carrying out a method as claimed in claim 1, the measuring system comprising at least one beam source for generating the input beam on the object side of the optical system, an optical measuring device on an image side of the optical system that is arranged so as to be linearly adjustable in the direction of the image-side optical axis of the optical system, and at least one apparatus for changing a direction of the input beam generated by the beam source.

9. The measuring system as claimed in claim 8, wherein the at least one apparatus for changing the direction of the input beam comprises an apparatus for achieving angular deflection of the input beam.

10. The measuring system as claimed in claim 9, wherein the apparatus for achieving the angular deflection comprises a rotatable mirror.

11. The measuring system as claimed in claim 8, wherein the at least one apparatus for changing the direction of the input beam is arranged so as to be adjustable transverse to the direction of the object-side optical axis of the optical system.

12. The measuring system as claimed in claim 8, comprising two identical, separately rotatable wedge plates for achieving angular deflection and/or parallel displacement of input beam.

13. The measuring system as claimed in claim 8, comprising an angle-measuring apparatus for the input beam.

14. The measuring system as claimed in claim 8, comprising an autocollimator serving as an angle-measuring apparatus for the input beam and as a beam source.

15. The measuring system as claimed in claim 8, wherein the measuring device comprises a camera chip connected to an image evaluation apparatus.

16. The measuring system as claimed in claim 8, comprising a beamsplitter.

17. The measuring system as claimed in claim 8, wherein the optical system comprises one or more focusing, defocusing or beam-deflecting optical elements.

18. A focusing apparatus for a laser processing installation, the focusing apparatus comprising a measuring system as claimed in claim 8 for controlling and readjusting a focal point of a laser beam.
